(19) United States
(12) Patent Application Publication
(10) Pub. No.: US 2008/0065483 A1
(43) Pub. Date: Mar. 13, 2008

(54) Inducing Renting Systems

(76) Inventor: Joe Ball, Phoenix, AZ (US)

Correspondence Address: LAW OFFICE OF ANDREW P. LAHSER, PLC, 13239 N. LA MONTANA, SUITE 215, FOUNTAIN HILLS, AZ, 85268, US

(21) Appl. No.: 11/771,409

(22) Filed: Jun. 29, 2007

Related U.S. Application Data
(60) Provisional application No. 60/825,577, filed on Sep. 13, 2006.

(51) Int. Cl. G06Q 30/00; G06Q 40/00

(52) U.S. Cl. 705/14

(57) ABSTRACT

This disclosure includes a description of a system for inducing renting of an item by acquiring an item, by a merchant in the business of renting a kind of the item. The system provides for advertising, to induce a consumer to rent the kind from the merchant, a rebate of a consumer's payment for rent whenever the consumer later purchases the kind from the merchant. The system provides for renting temporarily the item to a customer other than the consumer. The system provides for renting, without obligation to transfer title, the kind to the consumer in exchange for a payment-amount. The system provides for calculating a rebate-amount using a portion of the payment-amount. The system provides for selling, after renting temporarily, the item to the consumer for a sale-price minus the rebate-amount.

### CROSS REFERENCE TO RELATED APPLICATIONS

The present application is related to prior provisional application Ser. No. 60/825,577, filed Sep. 13, 2006, the contents of which are incorporated herein by this reference and are not admitted to be prior art with respect to the present invention by the mention in this cross-reference section.

### SUMMARY

This application discloses a system for inducing renting of an item that provides for acquiring an item, by a merchant in the business of renting a kind of the item; advertising, to induce a consumer to rent the kind from the merchant, a rebate of a consumer's payment for rent whenever the consumer later purchases the kind from the merchant; renting temporarily the item to a customer other than the consumer; renting, without obligation to transfer title, the kind to the consumer in exchange for a payment-amount; calculating a rebate-amount using a portion of the payment-amount; and selling, after renting temporarily, the item to the consumer for a sale-price minus the rebate-amount.

Further, this application provides for a system where the item has a finite useful life; and the step of selling occurs prior to expiration of four-fifths of the finite useful life. The system also may provide for assigning electronically an identifier to the consumer, storing electronically a reservation for rental of the kind associated with the identifier, storing electronically the rebate-amount associated with the identifier, and accounting periodically the rebate-amount to the consumer.

Also, the system provides for the kind to include passenger automobiles. The system may also provide for items such as passenger vehicles, recreational vehicles, cargo vehicles, machinery, heavy equipment, construction equipment, passenger airplanes. The system may also provide for items such as animals, sports equipment, clothing, jewelry, decorations, furniture, electronics, household appliances, or combinations thereof.

The system provides the step of advertising, which includes providing the consumer with an identification card associated with the identifier. The system provides for advertising including radio advertising, television advertising, newspaper advertising, internet advertising.

Also, the system provides for the portion of the rebate-amount to include substantially the entire payment-amount. The system provides for the portion to include an amount greater than fifty percent of the entire payment-amount. Further, the sale-price includes a price selected from the group consisting of the manufacturer's suggested retail price, the fair market price, the auction value of the item.

Further, the system provides that the merchant includes an organization such as a company, a franchisor-franchisee network, an association of merchants, or combinations thereof.

Finally, the system provides for determining the value of the item; and limiting the rebate-amount to a percentage of the value of the item.

### BRIEF DESCRIPTION OF THE DRAWINGS

FIG. 1 shows a diagrammatic view illustrating a system for inducing renting according to an embodiment.

FIG. 2 shows a use case diagram illustrating the actors and functions of a system for inducing renting according to an embodiment.

FIG. 3 shows an entity-relationship diagram illustrating relevant entities of a database system for inducing renting according to an embodiment.

FIG. 4 shows a diagrammatic view illustrating columns in a database table according to an embodiment.

FIG. 5 shows a symbolic view illustrating relations between company departments.

FIG. 6 shows a symbolic view illustrating relations between company departments according to an embodiment.

FIG. 7 shows a symbolic view illustrating relative value between various disposal methods according to an embodiment.

FIG. 8 shows a diagrammatic view illustrating steps in a process according to an embodiment.

FIG. 9 shows symbolic view of a billboard displaying a advertisement according to an embodiment.

FIG. 10 shows symbolic view of a television transmitting an advertising message according to an embodiment.

FIG. 11 shows symbolic view of a facsimile transmitting an advertising message according to an embodiment.

FIG. 12 shows symbolic view of a computer receiving an advertisement according to an embodiment.

FIG. 13 shows symbolic view of a renter's statement of account displaying a marketing message according to an embodiment.

FIG. 14 shows a symbolic view of a merchant in the business of renting passenger vehicles according to an embodiment.

FIG. 15 shows a symbolic view of a merchant in the business of renting household appliances or office equipment according to an embodiment.

### DETAILED DESCRIPTION

The present Inducing Renting Systems will now be discussed in detail with regard to the attached drawing figures, which were briefly described above. In the following description, numerous specific details are set forth illustrating the Applicant's best mode for practicing the Inducing Renting Systems and enabling one of ordinary skill in the art to make and use the Inducing Renting systems. It will be obvious, however, to one skilled in the art that the present Inducing Renting Systems may be practiced without many of these specific details. In other instances, well-known software systems, software methods, business methods and other method steps have not been described in particular detail in order to avoid unnecessarily obscuring this disclosure.

Rental companies rent items and later sell the same items in a used condition. Rental companies may have a rental department and a sales department, each trying to achieve independent goals, and perhaps competing with each other in some ways. One common goal of these departments may be to attract and retain customers, and keep them as repeat customers. In some companies, however, the primary focus of the company is on rentals, and the sales department may exist only to dispose of excess used rental items and return capital (bound up in used rental items) to working capital. In some embodiments, companies may rent automobiles, which are later sold. The primary focus of rental car companies is renting cars. Cars may be sold after their usefulness as a rental vehicle, but before expiration of its useful life. Vehicles may be sold by the rental car company itself to buyers at discount prices. Vehicles may be sold to retail customers or sold at auction for a lower price than even a discounted retail price. Many customers of the rental department are potential customers of the sales department, but the departments may not work together to attract and retain customers. There may be a lack of synergy between the sales departments and rental departments of companies.

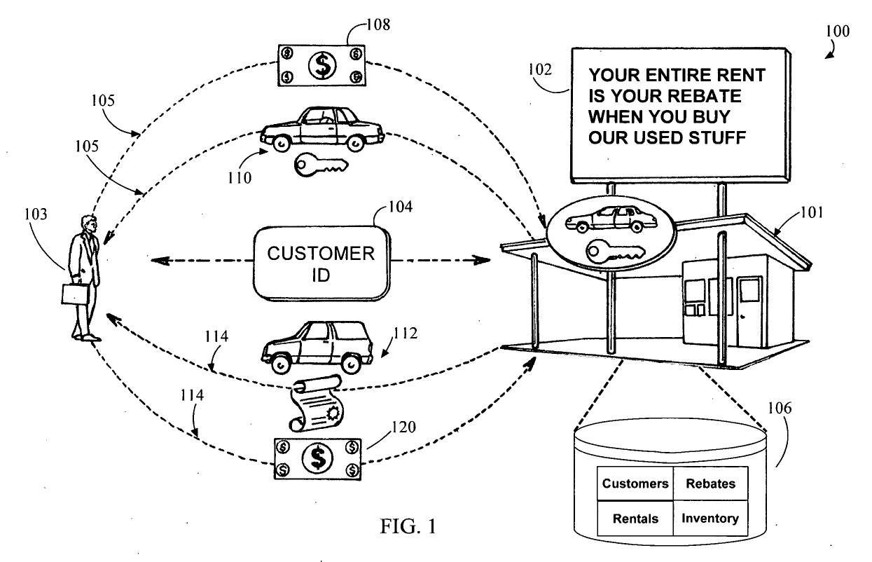

FIG. 1 shows a diagrammatic view illustrating system 100 for inducing renting according to an embodiment. Car-rental company 101 is a merchant in the business of renting cars, temporarily, to the consuming public. Car-rental company 101 advertises (or otherwise makes known) rebate 102 to customer 103 or the general public, as shown. Rebate 102 allows any customer, with a continuing relationship with car-rental company 101, to claim a rebate proportional to their rental fees whenever they later buy used rental equipment from car-rental company 101. Rebate 102 may be set to a relatively high proportion of the rental fees, as shown and discussed further herein. Car-rental company 101 may set the proportion of the rebate 102 such that customers, or the consuming public, may wish to rent exclusively or preferably from car-rental company 101.

The rental company may offer rental customers a 100 percent, greater than 100 percent, or nearly 100 percent rebate proportion on the cost of renting an item, which rebate can be applied to the purchase of any item from the same company. The rebate applied may be limited to a percentage of the purchase price of the vehicle. A customer of the rental department may be given an incentive to purchase an item from the company and the rental department will attract customers for the sales department and possibly vice versa. When a potential customer of the sales department may be interested in purchasing an item from the sales department, they will be encouraged to use the rental department for all their rental needs, so that the costs of renting may be applied to the purchase of an item. The potential customer of the sales department may even rent an item for the purpose of evaluating the type of item, and then purchase a similar item from the same company without extra costs for a long evaluation period. The sales department will attract customers for the rental department, and the two departments may provide a synergistic sales effect for the company. The program may also provide the effect of encouraging repeat customers for both departments.

Customer 103 makes a reservation with car-rental company 101. Car-rental company 101 may assign customer id 104 to customer 103 at the time of the reservation, at the time of rental, or other convenient time, as shown. Car-rental company 101 may store information related to customer 103, customer id 104, reservations, and the relationship between them in database 106, as shown. On the date of the reservation, customer 103 and car-rental company 101 exchange rent for temporary usage of a vehicle by rental-transaction 105, as shown. Customer 103 may provide payment 108 to car-rental company 101 in consideration of rental-transaction 105, as shown. Payment may be made in cash, credit, debit, account, other legal tender, or any combination. Car-rental company 101 may provide passenger car 110, temporarily, as a vehicle for hire as part of rental-transaction 105, as shown. Car-rental company 101 may store information related to rental-transaction 105 in database 106, as shown. Car-rental company 101 may account (periodically, upon completion of a transaction, or from time-to-time) to customer 103 regarding prior rental transactions, rental-transaction 105, accumulated rebate amount, sales-transaction 114, other information, which may be stored in database 106, as shown.

Car-rental company 101 and customer 103 may engage in many transactions similar to rental-transaction 105. Car-rental company 101 may rent passenger car 110 or other similar vehicles to the public. Car-rental company 101 may rent SUV 112 during its finite useful life, that is, SUV 112 will only function as a passenger vehicle for a limited amount of time. Car-rental company 101 may choose to rent vehicles, such as SUV 112 or passenger car 110, for a period less than the finite useful life, such as, for example, one year, two years, three years, four years, five years, etc. The useful life may be measured in terms of usage, such as, for example, the mileage of a vehicle, or its odometer reading. The useful life may be measured by the condition of the rental vehicle, such as, for example, wear-and-tear, collisions, repairs, maintenance costs, etc. Car-rental company 101 may select such period based on the expectations of its customer, or the consuming public, for quality and/or reliability of the rental vehicle. Car-rental company 101 may select such period based on the profitability of renting a vehicle for any period compared to any other period. Car-rental company 101 may select such period for other factors, as further discussed herein.

Car-rental company 101, after the period for renting has expired and it is no longer desirable to rent the vehicle, may wish to sell SUV 112, because, in part the entire useful life of the vehicle may not have expired, as shown. Car-rental company may dispose of used vehicles, such as SUV 112, by auction, by fleet sales, or by scrap. Car-rental company 101 may wish to sell SUV 112 directly to customer 103, or other customer as shown. Car-rental company 101 may conduct such sales as an auction, an online auction, through its physical locations, or other methods. Car-rental company 101 may store information related to passenger car 110, SUV 112, other rental vehicles, their useful lives, their acquisition or manufacture date, their term of service as a rental vehicle, or combinations thereof in database 106, as shown.

Car-rental company 101 agrees to sell SUV 112 pursuant to sales-transaction 114, as shown. During sales-transaction 114, car-rental company 101 may transfer SUV 112, including title, to customer 103, as shown. Car-rental company 101 and customer 103 may agree to a purchase price for SUV 112, as shown. Car-rental company 101 may reduce the purchase price for SUV 112 by an amount equal to the amount that customer 103 may claim pursuant to rebate 102 or similar rebates offered by car-rental company 101, as shown. Car-rental company 101 may use customer id 104 to determine the amount of such claim.

Alternately, car-rental company 101 may accept payment 120 partly in cash (or other legal tender) and party as a credit for any amount that may be claimed by customer 103 pursuant to rebate 102 or similar rebates, as shown. Alternately, car-rental company 101 may accept payment 120 fully as a credit for any amount that may be claimed by customer 103 pursuant to rebate 102 or similar rebates, as shown. Car-rental company 101 may store information related to transaction 114, used car inventory, customer credits, customer id, and the relationships and combinations thereof, in database 106, as shown.

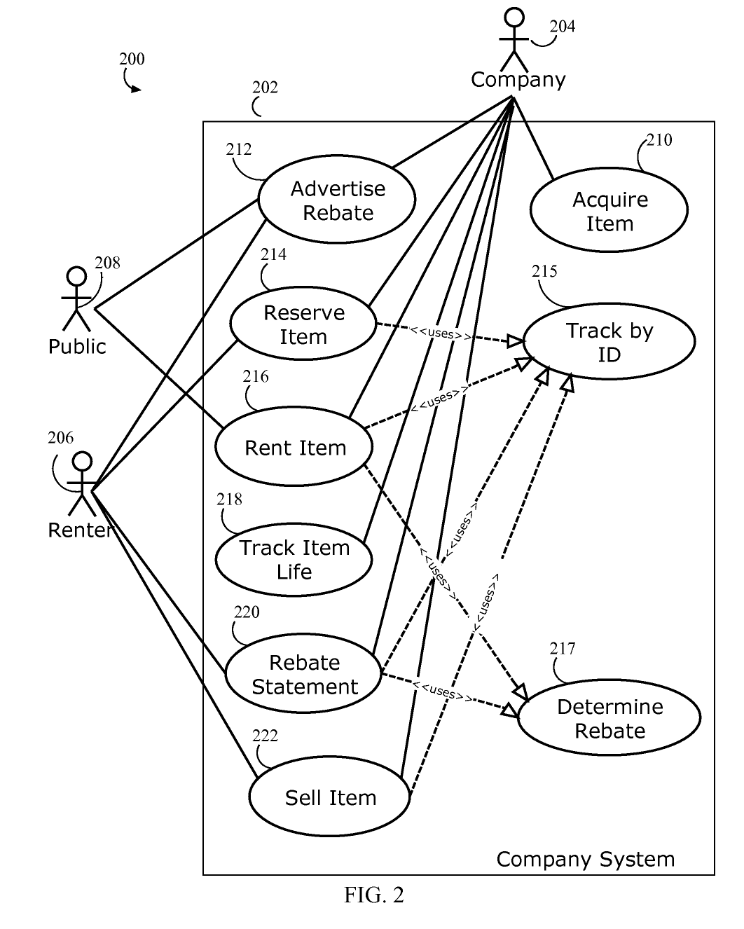

FIG. 2 shows a use case diagram illustrating the actors and functions of system 200 for inducing renting according to an embodiment. Computer system 202 provides various functions for the benefit of the various actors: company 204, renter 206 (a customer or consumer, used interchangeably herein), and public 208 (also herein sometimes referred to as a customer or consumer), as shown in the use case diagram.

Computer system 202 may include a variety of structures to provide these functions for the various embodiments. Computer system 202 may include a computer including an input device (e.g. keyboard, mouse, etc.) and an output device (e.g. display, printer, etc.), and device to communicate with a network of computers (e.g. Ethernet, token ring, etc.). Computer system 202 may also include software. The software functions that establishes and records a customer rebate account may include functions, such as recording the value of a customer rebate account, adding value to the customer rebate account, and subtracting value from the customer rebate account, as shown by this diagram.

Company 204 may be a merchant in the business of renting goods. Renter 206 may be a particular customer of company 204. Public 208 may be other customers or potential customer of company 204. Company 204 may use acquire-item function 210 to record the acquisition of a new rental item, including such details as the type of item, its rental rate, rebate programs associated with the item, date of manufacturer, location, or any other information that company 204 may desire to track.

Company 204 may use advertise-rebate function 212 to record the various advertising programs that offer the rebates to public 208, renter 206 or both. Advertise-rebate function 212 may track the expiration date of the rebate, the terms of the rebate, other qualifications for the rebate.

Company 204 may use reserve-item function 214 to record the reservations of renter 206, as shown. Reserve-item function 214 may record aspects of taking a reservation on behalf of renter 206, such as, for example, the date and time of the rental, rental duration, the type of rental equipment, the rental amount, estimated charges, payment information, renter's contact information, etc. Reserve-item function 214 may use the track-by-id function 215 to assign a unique customer-id to renter 206. Track-by-id function 215 assigns customer-id, which may be a unique identifier created by the function, a unique identifier provided by renter 206 (like a phone number, social security number, or email address), or any other method or information that allows association between renter 206 and information stored in computer system 202.

Company 204 may use rent-item function 216 to record transactions between public 208 and company 204, as shown. Rent-item function 216 may record any relevant details of the rental transactions, such as, for example, the rental date, amount charged for the rental period, how long the rental period extended, how much of the useful life was used during the rental period, the condition of the rental item upon return, any rebate programs that apply to the rental transaction. Rent-item function 216 may use the determine-rebate function 217, as shown. Determine-rebate function 217 calculates and stores any rebate amount associated with a rental transaction. Determine-rebate function 217 may (directly or indirectly) use the customer id and/or track-by-id function 215.

Company 204 may use track-item-life function 218 to monitor the aging of inventory of rental items. Track-item-life function 218 may be queried to determine the remaining useful life of a specific rental item. Track-item-life function 218 may be queried to determine which inventory items have passed their useful life or may no longer be desirable to rent. Track-item-life function 218 may be used to determine which vehicles are ready to be disposed at auction, by sale, or by scrap.

Company 204 may use rebate-statement function 220 to create statements of rebate amounts for renter 206. The rebate-statement may contain a history of any rental transactions, the rebate-program in effect at the time of each transaction, the amount spent on the rental transaction, and/or the rebate-amount that can be applied to the purchase price of used rental item inventory. Rebate-statement function 220 may provide statements periodically, such as by monthly or after each rental transaction. Rebate-statement function 220 may provide statements on demand, such as by an automated telephony inquiry system or whenever sending correspondence to renter 206.

Company may use sell-item function 222 to record the details of selling a rental item to renter 206. Sell-item function 222 may determine and record the purchase price for renter 206 by calculating the appropriate purchase price and then reducing that price by the amount of any eligible rebate amounts of renter 206.

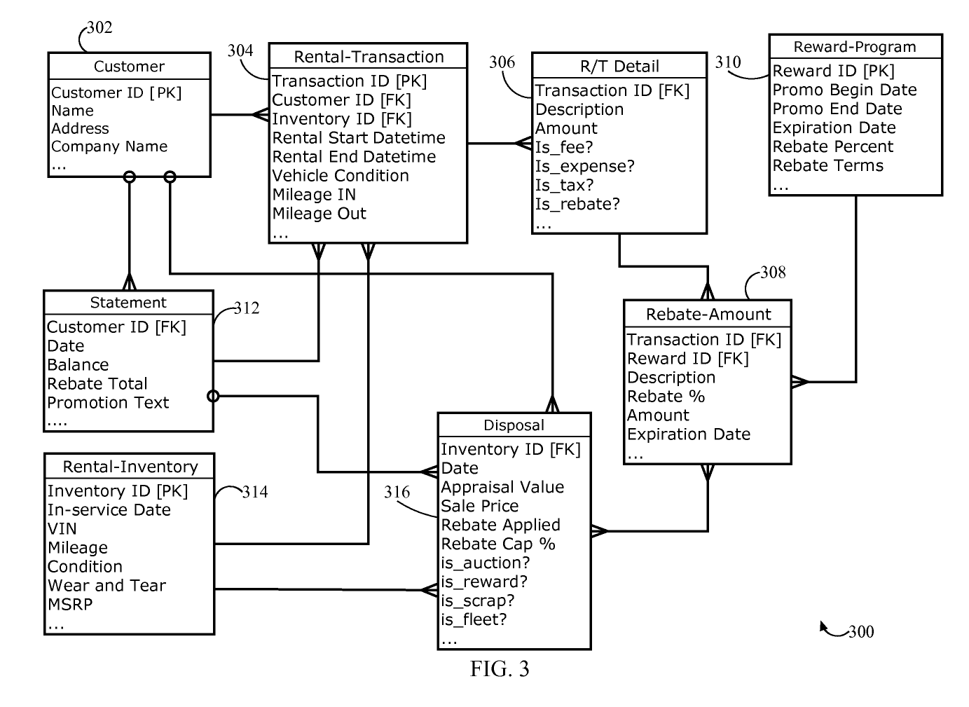

FIG. 3 shows an entity relationship diagram illustrating relevant entities of database system 300 for inducing renting according to an embodiment. Database system 300 contains representative entities for tracking information required to track customers, rental transactions, rebate programs, rental inventory, rebate amounts, statements and redemptions. Database system 300 may use more or less entities, as required or desired by the rental company. The individual entities may have more or less attributes, as required or desired by the rental company. The relationships shown are high level, with some relationships omitted for clarity. Some attributes are noted as primary keys (PK) or foreign keys (FK), but these are not the only primary or foreign key combination possibilities. In other words, this entity-relationship model illustrates one configuration of a relational database application for implementing inducing renting systems. Database system 300 may be any computer system or other structure that includes electronically readable memory. Database system 300 may be a relational database system, hierarchical database system, flat-file system, etc.

Customer 302 is an entity that represents a database table for storing information about customers of the rental company. Customer 302 contains various attributes, including customer id (which may serve as the primary key), name, address, company name and any other attribute, which is related to the customers. The customer id attribute may be a system assigned number. The customer id attribute may be embodied on a card or keychain that is provided to the customer. The customer id may be a frequent customer number. The name attribute is an alpha-numeric field of sufficient length to contain the name of the customer. The address attribute may be a series of fields, or a single field that can contain information suitable for addressing information by regular mail.

Information pertaining to rental transactions may be stored in a database table represented by rental-transaction 304, as shown. Rental-Transaction contains attributes such as transaction id (which may serve as the primary key), customer id (which may serve as the foreign key to customer 302, inventory id (which may serve as the foreign key to rental-inventory 314) the rental-start datetime, rental-end datetime, and any other attribute, which may be related to the rental transaction. These datetime attributes may be fields capable of storing the date (or the date and time) that the rental began and ended. In embodiments involving rental of rental vehicles, other attributes may be desirable, such as, for example, the vehicle condition, the mileage at the beginning and end of the rental period, and other details required or desirable for renting a vehicle. The vehicle condition attribute may include fields that indicate the status of various car components, such as the interior, exterior, various body panels, etc. Rental-transaction 304 may include rental-transaction detail 306, as shown. Rental-transaction detail 306 may include attributes pertaining to line-items on a rental-transaction, such as, for example, transaction id (which may be the foreign key to rental-transaction 304), a description of the line item, the amount of the line item, whether the line-item is a fee, an expense, tax, rebate, incentive, etc. In embodiments involving automotive rentals, the line-items may also relate to fuel charges, airport usage fees, parking charges, or other incidental expenses.

Rebate-amount 308 is an entity that represents a table for storing information about the amounts that may be claimed as rebates due to a rental-transaction during a reward program, as shown. Rebate-amount 308 contains attributes associated with information needed to later calculate the amount of a rebate owed to a particular customer for a particular transaction. Rebate-amount 308 includes attributes, such as, for example, the transaction identifier (which serves as the foreign key to rental-transaction 304), the reward identifier (which serves as the foreign key to reward-program 310), a textual description of the rebate-program, the percentage of the rental-transaction, the rebate terms, the rebate percentage, the expiration date, the rebate amount, or any other information necessary or desirable to determine the rebate amount that may be due to the customer 302. A record in rebate-amount 308 may be associated with one or more records in disposal 316, as shown.

Reward-program 310 is an entity that represents a database table for storing information about the reward programs that are offered to the customer and/or the public. Reward-program 310 may contain attributes associated with information regarding the terms of the reward program, such as, for example, a reward identifier (to serve as the primary key), the beginning and ending dates, the expiration date (which is the last date that the rebate may be redeemed), the rebate percentage, and any other rebate terms. Records in reward-program 310 may be associated with records in rebate-amount 308, as shown.

Statement 312 is an entity that represents a database table for storing information about the accounting statements that the rental company sends to their customers regarding their rental transactions. Statement 312 may contain attributes associated with information contained in statements that are sent to the customer. These attributes may include the customer identifier, the date of the statement, the balance due, the rebate total, and promotion text, etc. Statement 312 may also have an associated detail entity (similar in purpose to rental-transaction detail 306) or entities. Statement 312 may also relate to information on disposal 316, whenever the company disposes of used rental items to a particular customer who redeemed a rebate.

Rental-inventory 314 is an entity that represents a database table for storing information about the rental inventory in service with the rental company. Rental-inventory 314 may contain attributes associated with information pertaining to the rental equipment. These attributes may include a inventory identifier (which may serve at the primary key), the date put in service, the remaining useful life (estimate or actual), condition of the equipment, etc. In automotive embodiments, other attributes may be desirable, such as, for example, the vehicle identification number (VIN), inventory tracking numbers, mileage, wear and tear, the manufactured suggested retail price, etc.

Upon disposition of rental equipment, the company may create a record in the entity disposal 316, which may contain records with information about how the rental equipment is disposed. Disposal 316 may contain attributes, such as, for example, the date of disposition, the appraisal value, the actual sales price, the amount of any rebate applied pursuant to a reward program, etc. In automotive embodiments, other attributes may be desirable, such as, for example, mileage, type of disposition (auction, reward/rebate to customer, scrap, fleet sale, etc.)

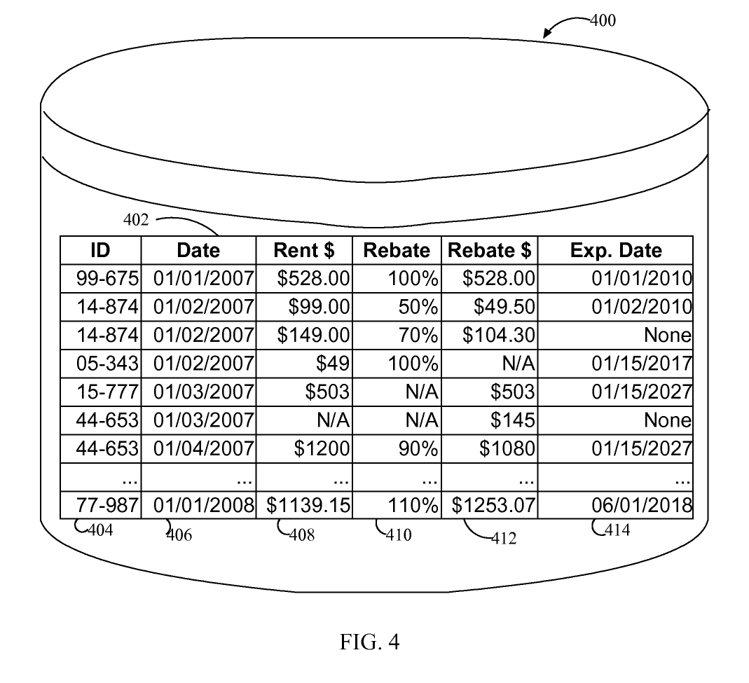

FIG. 4 shows a diagrammatic view illustrating columns in a database table according to an embodiment. Computer-storage 400 contains file 402, which has columns that store information for recording rental activity including rebate entitlement information, as shown. These columns are stored in a format that may be later read from electronically readable memory. These columns may include identifier 404 for identifying a customer or rental transaction, rental-date 406, paid-rent 408, rebate-percentage 410, rebate amount 412, and expiration date 414. The table of data shows that not all columns are required. For example, if the rent amount and rebate percentage are known values, then the rebate amount may be calculated. The rebate amount may store the value of the customer rebate eligible for use in purchasing an item from the company. The value stored in the rebate amount may be equal to or greater than the price paid by the customer for renting an item from the customer. In another embodiment, the value stored in the rebate amount may be a high percentage of the total amount of the rental price. The expiration date could be non-expiring. File 402 may be a separate file used specifically for tracking information related to the rebate programs. File 402 may be integrated into other electronic systems, such as an automated accounting system, electronic general ledger system, customer relationship management system (CRM), internet web portal system, point of sale system, etc. The computer may determine the sum total for all rebate amounts that are due to a customer by querying file 402.

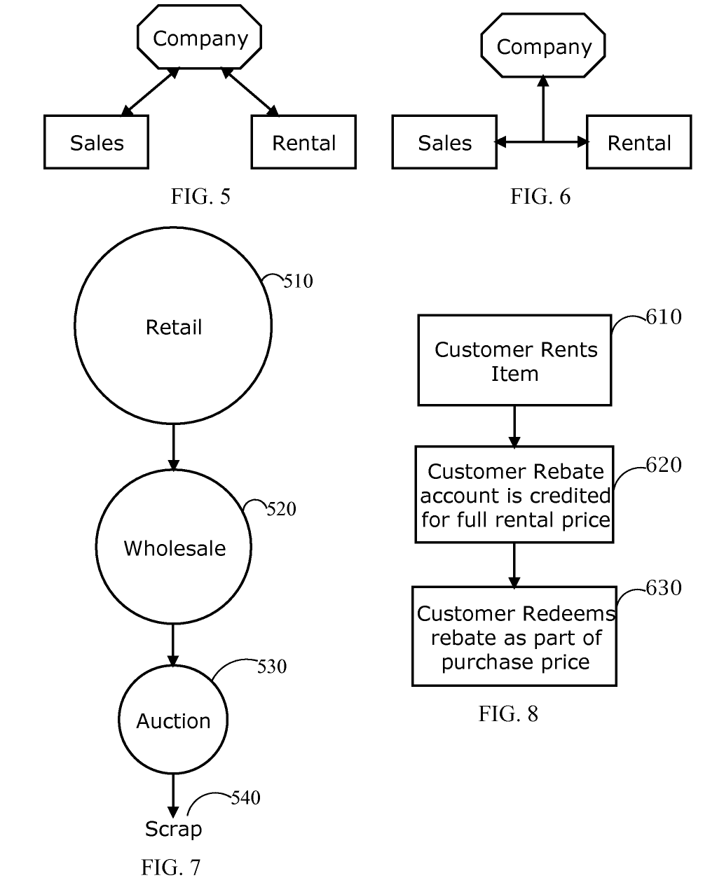

FIG. 5 shows a symbolic view illustrating relations between company departments. Rental companies may have separate rental and sales departments relate (i.e. fail to relate directly). The rental department may have individual goals, and does not promote or deal with the sales department. Likewise, the sales department may have goals separate and distinct from the rental department. The only relation between the two departments may be through upper management. Each department may independently spend millions of dollars to attract and retain customers, through separate advertising methods.

FIG. 6 shows a symbolic view illustrating relations between company according to an embodiment. The sales and rental departments may operate together as the rental department may drive customers to the sales department, and the sales department may drive customers to the rental department. In another embodiment, the marketing costs of the two departments may be combined and may attract more loyal customers.

FIG. 7 shows a symbolic view illustrating relative value between various disposal methods according to an embodiment. Some common disposal methods are retail, wholesale (or fleet sales), auction, and scrap (or junk yard). The value obtained for the car may generally reflect the method of disposition, as shown. The company may sell a used rental car directly to the customer, (i.e. at retail 510), for the current listed retail price, for the manufacturer's suggested retail value, for the appraisal value, for the blue-book value, etc. For vehicles that may not be sold at retail 510, the vehicles may be sold at wholesale 520, where the price may be forty percent (40%) less than retail. Fleet or wholesale disposition may be bulk sales to card dealers who will resell the vehicles at retail. This disposition method may result in less value per vehicle, lower transactions costs, with improved capital management and lower overheard/storage costs. In another embodiments (with other types of rental equipment), other disposition methods may be available for other types of rental property or equipment.

The rental company may sell the vehicle at auction 530. Many auctions may be attended primarily by other car dealers, which may be competitors of the car rental company. Auction prices may be lower than wholesale prices. Also, when a car is sold at wholesale or auction price, the car may be sold to a competitor of the rental company's sale department. This competitor may be receiving the benefit of a low priced vehicle, which may be resold to the public at retail 510. That is to say, the difference between the auction price and price at retail 510 may be an advantage given to competition.

There are other options for disposal of the vehicle, such as, for example, a donation to charity, or sale for parts to a junk yard (i.e. scrap 540). Whenever these options used frequently, such as, for example, after a natural disaster damages a large number of vehicles at one time, significant value may be lost.

The various disposal values may be illustrated using the following example. If a 1 year old car of a specified model and make with 20,000 miles is selling at retail for $17,000 (or if the blue book value is $17,000), this may be the value at retail 510. If the company tried to sell directly at retail, but the vehicle did not sell quickly enough, the company may choose to sell the vehicle at wholesale 520, which may have a value of $12,000. In this example, there is a difference of $5,000 between the retail and wholesale value of the vehicle. The company may sell the vehicle to a customer for a price below the retail value, and above wholesale value, for instance at $14,000. Some cars of a specific make and model will sell for higher than other cars, due to other factors, but they may average below retail by $3,000. If the car is sold at auction 530, the price for the vehicle may average $10,000 after the auction costs, which is $2,000 below the wholesale value, $4,000 below average retail selling price (value), and $7,000 below the full retail selling price (value).

FIG. 8 shows a diagrammatic view illustrating steps in a process according to an embodiment. The process of marketing and selling vehicles may involve a customer renting a vehicle during step 610. The customer may be given a rebate of the full rental price, which is credited to an account during step 620. The customer can then purchase a vehicle from the company using the rebate value as a down payment during step 630. For a nationwide, or world wide company this rebate program may allow a customer to visit one city on vacation, or for a business trip, and make a decision of which rental car company to rent a car from. The customer may rent a vehicle on vacation, and then purchase a car when they return home, giving the customer an incentive to rent from the rental company. The customer may also accumulate value on the rebate account by renting several different vehicles at different times, so that a large portion of the purchase price may be paid with the rebate account. As the customer has many opportunities to rent vehicles, the synergistic marketing method may encourage the customer to use the same company in order to build the value in the rebate account. Such a program may encourage customer loyalty.

Customers may also be encouraged by the rebate program to become a loyal customer of the sales department. Vehicles are an example of an item of which a customer may purchase used. As consumers have a choice when they purchase used items such as vehicles or other equipment, they may be more likely to purchase from a company where they already have credit. The rebate program provides an incentive for customers to be loyal, repeat customers of the sales department, even when purchases are years apart.

In an embodiment, the rebate account may be extended to another person or entity, other than the one renting the equipment or item. The rebate account value may be transferable, so that the value in the account can be given as a gift, or transferred in some other way, including selling the account. The rebate account may also be used by a company that pays for rentals, as a rewards program for employees. For instance if a customer-corporation rents cars for employees on business trips, it may reward key employees, or high performing employees with a transfer of the balance in the rebate account, thereby allowing the employee to purchase a vehicle, for example, without a down payment, and at a discounted rate.

In an embodiment, the customer may use the rebate account for the full retail price of a vehicle. For instance if the full retail price of a vehicle is $20,000 and the customer has paid $20,000 to rent vehicles, then the customer may be allowed to purchase the $20,000 vehicle using only the rebate account of $20,000. The price of renting vehicles may be higher so that a deeper discount may be offered on the sale of the vehicles, and the customer may be given the option to participate in the synergistic marking plan at a different price than those who do not participate in the marking plan.

In another embodiment, the rebate program may include a cap on the percentage of the purchase price that can be applied by using the rebate account. The percentage cap may be at a different value for different items sold by the company. In another embodiment, the synergistic marketing method may have a rebate for the rental, which is greater than the price paid for the rental of the item. For instance if price paid to rent the item was $500, then the rebate applied to the account could be 200% of the price paid which is $1,000. This may encourage customers to rent vehicles or other items, for instance, at a time of year when less people typically rent the items.

The rebate program may ensure that items that would otherwise be sold to competitors at discount prices would be sold to customers using all or part of the rebate account for the purchase price of the vehicle. The rebate program may allow the average price of a vehicle sold to be no higher than without using the rebate program because the benefit of low priced vehicles will be transferred to the customers who are likely to become loyal customers using the plan.

As an example, the customer may rent several different vehicles. The value of those rentals may be applied to a rebate account to give the customer a potential rebate of $3,400. The customer may then come to the sales department interested in purchasing a specific make and model vehicle. The company may cap 20% of the purchase price for the specific make and model vehicles, i.e., up to 20% of the purchase price may be applied to the purchase of that specific make and model vehicle from the customers rebate account. If the customer purchases the vehicle for the retail value of $17,000 then 20% would be $3,400 and the customer would pay $13,600 for the vehicle. The $13,600 may be similar to the average wholesale value of the vehicle, which may be $14,000.

The percentage cap rate on the vehicles sold may vary depending on the quantity of used inventory that the company needs to dispose. For instance, if a company may not sell quickly a certain make and model, that make and model may have a higher cap, such as 25%, 30%, 35%, or higher. The percentage cap may be related to the blue book value of the vehicle compared to the average auction value of the vehicle. The total average selling price for a make and model may depend on how many vehicles are sold at wholesale or at auction. The value may be far below the cost of the vehicle sold at 25% below the full retail value, or may even be below 25% of the average retail selling price. As more customers have the incentive to purchase an item from the company, less vehicles may be sold at wholesale or at auction, and the total average sale price of a vehicle may increase. Further customers using the rebate program will rent vehicles from the company, thereby increasing the demand for rental items. The result may result in synergistic marketing between the two departments, in attracting and retaining customers.

As a further example, when a vehicle may be acquired through financing, (i.e. when a bank or lending institution agrees to advance funds in exchange for payments), the bank may not want to advance the full price of the vehicle or other item. As with the example above, a vehicle of a specific make and model may be sold for $17,000 to a customer. The customer pays $3,400 using the rebate account and the bank advances $13,600 so long as the customer agrees to make payments until the amount advanced is paid in full, with any interest. Customer may purchase a vehicle without using money from their personal funds or impacting their cash flow. Some customers may not have funds for a down payment, but, using the rebate program these customers may qualify for financing and purchase the used rental vehicles. Also, when a customer does not have the down payment for a vehicle and must rent a vehicle until they can obtain the funds for a down payment, the cost of renting may be applied towards the down payment, allowing the customer to be eligible for purchase sooner. These financing, percentage cap and other terms have been described in terms of the automobile rental embodiment, but the principles explained herein may apply for other types of rental items.

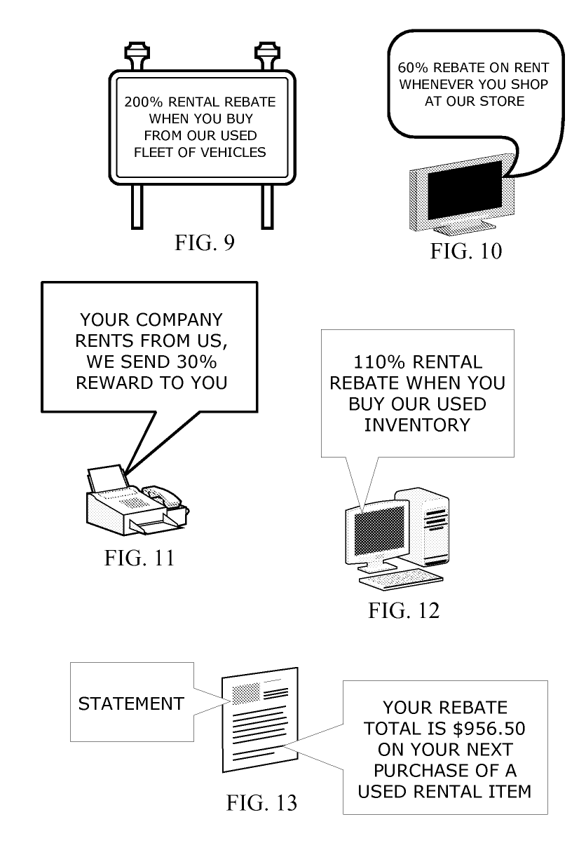

FIG. 5 through FIG. 9 show various symbolic views of advertising messages and advertising mediums according to various embodiments. FIG. 5 shows symbolic view of a billboard displaying an advertisement according to an embodiment. FIG. 6 shows symbolic view of a television transmitting an advertising message according to an embodiment. FIG. 7 shows symbolic view of a facsimile transmitting an advertising message according to an embodiment. FIG. 8 shows symbolic view of a computer receiving an advertisement according to an embodiment. FIG. 9 shows symbolic view of a renter's statement of account displaying a marketing message according to an embodiment.

FIG. 9 through FIG. 13 show that various advertising mediums may be used to communicate or otherwise raise awareness of the rebate program, such as, for example, billboards, television commercials, radio commercials, newspaper advertising, print advertising, infomercials, fax broadcasting, internet pay-per-click advertising, internet banner advertising, email advertising, direct mail advertising, relationship-based advertising to existing customers, etc.

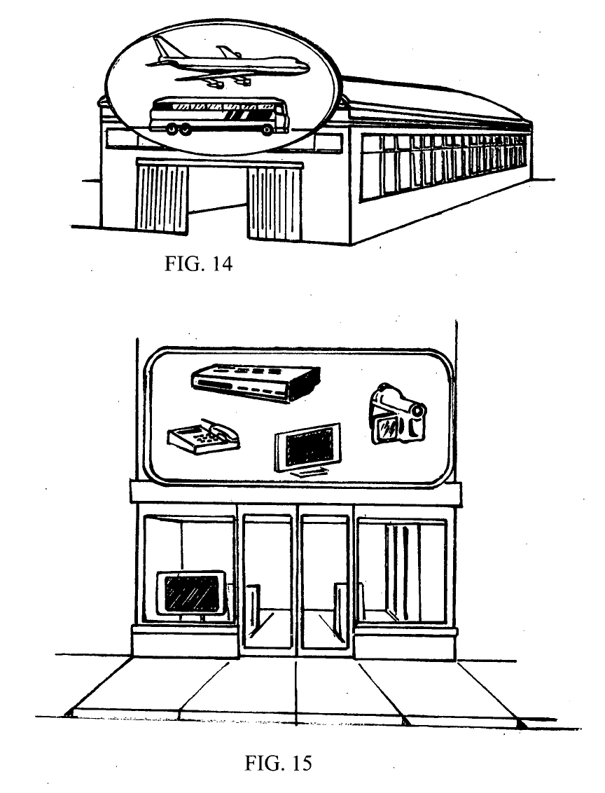

FIG. 9 through FIG. 13 show that the advertising message and/or the underlying rebate program may be adjusted to improve effectiveness for the advertising medium. For example, FIG. 13 shows a specific dollar and cents amount on a customer's statement, which details the rebate that is available for the purchase of previously-rented items. FIG. 11 shows that the renter name may be used when sending a fax to a particular rental-customer. Other figures show that changing the terms, such as the percentage rebate, from one advertising medium to the next, may be desirable to improve effectiveness and profitability of the advertising campaign and the rebate program.

FIG. 14 shows a symbolic view of a merchant in the business of renting passenger vehicles according to an embodiment. FIG. 15 shows a symbolic view of a merchant in the business of renting household appliances, electronics or office equipment according to an embodiment. Together, FIG. 14 and FIG. 15 show that other types of merchants, other than car-rental companies, can use similar advertising and marketing programs to help create and renew customer loyalty. Merchants may market any kind of item that may be rented and sold, or that may in the future be both rented and sold, including but not limited to, passenger vehicles, motorcycles, cargo vehicles, machinery, heavy equipment, construction equipment, passenger airplanes, cargo airplanes, boats, yachts, ships, condominiums, houses, timeshares, animals, sports equipment, clothing, jewelry, decorations, and furniture.

More than one rental company (i.e. an association of rental companies, a franchise network, a merchant association or chamber, or other entities) may use the synergistic marketing method to act as one company with multiple departments, even if the two companies are separate and distinct entities. The association may benefit by attracting more customers, and both companies retaining loyal customers. Such a scheme may be even more synergistic when the offerings of the associated companies are non-overlapping in terms of product offerings (e.g. company A rents cars, company B rents office equipment), geographic location (e.g. company C rents in the Midwest, company D rents in the Southwest), demographics, etc.

Although applicant has described applicant's preferred embodiments of this invention, it will be understood that the broadest scope of this invention includes modifications and implementations apparent to those skilled in the art after reading the above specification and the below claims. Such scope is limited only by the below claims as read in connection with the above specification. Further, many other advantages of applicant's invention will be apparent to those skilled in the art from the above descriptions and the below claims.

What is claimed is:

1. A system for inducing renting of an item comprising the steps of:
acquiring an item, by a merchant in the business of renting a kind of the item;
advertising, to induce a consumer to rent the kind from the merchant, a rebate of a consumer's payment for rent whenever the consumer later purchases the kind from the merchant;
renting temporarily the item to a customer other than the consumer;
renting, without obligation to transfer title, the kind to the consumer in exchange for a payment-amount;
calculating a rebate-amount using a portion of the payment-amount; and
selling, after renting temporarily, the item to the consumer for a sale-price minus the rebate-amount.

2. The claim of claim 1 wherein:
the item has a finite useful life; and
the step of selling occurs prior to expiration of four-fifths of the finite useful life.

3. The claim of claim 1 wherein:
assigning electronically an identifier to the consumer,
storing electronically a reservation for rental of the kind associated with the identifier,
storing electronically the rebate-amount associated with the identifier, and
accounting periodically the rebate-amount to the consumer.

4. The claim of claim 3 wherein:
the step of advertising comprises providing the consumer with an identification card associated with an identifier.

5. The claim of claim 1 wherein:
the kind comprises passenger automobiles.

6. The claim of claim 1 wherein:
the kind comprises one selected from the group consisting of passenger vehicles, recreational vehicles, cargo vehicles, machinery, heavy equipment, construction equipment, passenger airplanes.

7. The claim of claim 1 wherein:
the kind comprises one selected from the group consisting of animals, sports equipment, clothing, jewelry, decorations, furniture, electronics, household appliances, or combinations thereof.

8. The claim of claim 1 wherein:
the kind comprises one selected from the group consisting of houses, condominiums, timeshares, or combinations thereof.

9. The claim of claim 1 wherein:
the kind comprises one selected from the group consisting of boats, ships, yachts, or combinations thereof.

10. The claim of claim 1 wherein:
the step of advertising comprises one selected from the group consisting of radio advertising, television advertising, newspaper advertising.

11. The claim of claim 1 wherein:
the step of advertising comprises internet advertising.

12. The claim of claim 1 wherein:
the portion comprises substantially the payment-amount.

13. The claim of claim 1 wherein:
the portion comprises an amount greater than fifty percent of the payment-amount.

14. The claim of claim 1 wherein:
the sale-price comprises a price selected from the group consisting of the manufacturer's suggested retail price, the fair market price, the auction value of the item.

15. The claim of claim 1 wherein:
the merchant comprises an organization selected from the group consisting of a company, a franchisor-franchisee network, an association of merchants, or combinations thereof.

16. The claim of claim 1 further comprising the step of:
determining the value of the item;
wherein the step of calculation further comprises the step of limiting the rebate-amount to a percentage of the value of the item.

17. A system for inducing renting of an item comprising the steps of:
acquiring an item, by a merchant in the business of renting a kind of the item;
advertising, to induce a consumer to rent the kind from the merchant, a rebate of a consumers' payment for rent whenever the consumer later purchases the kind from the merchant;
renting temporarily the item to a customer other than the consumer;
maintaining a computer, wherein the computer comprises
a first program to assign an identifier to the consumer,
a second program to capture information related to renting the kind to the consumer, wherein the information comprises the identifier and the payment-amount,
a third program to calculate a rebate-amount using the information, and
a database to store, in electronically readable memory, the identifier, an association between the identifier and an amount selected from the group consisting of the payment-amount, the rebate-amount, the rebate ratio, and combinations thereof;
accounting to the consumer using the database; and
selling, after renting temporarily, the item to the consumer in exchange for a sale-price minus the rebate-amount.

18. The claim of claim 17 wherein:
the item has a finite useful life; and
the step of selling occurs prior to expiration of four-fifths of the finite useful life.

19. The claim of claim 18 wherein the computer further comprises:
a fourth program to assign electronically the identifier to the consumer,
a fifth program to account periodically the rebate-amount to the consumer, and
said database to store, in electronically readable memory, a reservation for rental of the kind associated with the identifier, and the rebate-amount associated with the identifier.

20. A system for inducing renting of passenger cars comprising the steps of:
acquiring a car, by a merchant in the business of renting passenger vehicles;
advertising, to induce a consumer to rent at least one of the passenger vehicles from the merchant, a rebate of a percentage of a consumer's payment for rent whenever the consumer later purchases at least one of the passenger vehicles from the merchant;
renting temporarily the car to a customer other than the consumer;
renting, without obligation to transfer title, at least one of the passenger vehicles to the consumer in exchange for a payment-amount;
maintaining a computer, the computer performing the steps of
calculating a rebate-amount by multiplying the payment-amount by at least one hundred percentage points; and
selling, after renting temporarily and before the car passes four-fifths of the car's useful life, the car to the consumer for the manufacturer's suggested retail price minus the rebate-amount.

21. The claim of claim 20 further comprising the step of:
accounting periodically the rebate-amount to the consumer;
wherein the step of maintaining the computer further comprises the steps of
assigning an identifier to the consumer,
storing a reservation for rental of at least one of the passenger cars associated with the identifier, and
storing the rebate-amount associated with the identifier.

22. The claim of claim 21 wherein:
the percentage is the portion of the consumer's payment related to rental of such item.

23. A system for inducing renting of an item comprising:
acquiring means for acquiring an item, by a merchant in the business of renting a kind of the item;
advertising means for advertising, to induce a consumer to rent the kind from the merchant, a rebate of a consumer's payment for rent whenever the consumer later purchases the kind from the merchant;
temporarily-renting means for renting temporarily the item to a customer other than the consumer;
renting means for renting, without obligation to transfer title, the kind to the consumer in exchange for a payment-amount;
calculating means for calculating a rebate-amount using a portion of the payment-amount; and
selling means for selling, after renting temporarily, the item to the consumer for a sale-price minus the rebate-amount.

24. The claim of claim 23 wherein:
assigning means for assigning electronically an identifier to the consumer,
reservation-storing means for storing electronically a reservation for rental of the kind associated with the identifier,
rebate-storing means for storing electronically the rebate-amount associated with the identifier, and
accounting means for accounting periodically the rebate-amount to the consumer.
